(19) United States
(12) Patent Application Publication
(10) Pub. No.: US 2026/0238152 A1
(43) Pub. Date: Aug. 13, 2026

(54) METHOD AND DEVICE FOR FEEDBACK CONTROL OF MOTOR BASED ON PULSE WIDTH MODULATION

(71) Applicant: Zhongshan Broad-Ocean Motor Co., Ltd., Zhongshan (CN)

(72) Inventors: Yuanhua LI, Zhongshan (CN); Xiansheng ZHANG, Zhongshan (CN); Feilai LI, Zhongshan (CN); Hairong SUN, Zhongshan (CN)

(21) Appl. No.: 19/428,275

(22) Filed: Dec. 21, 2025

(30) Foreign Application Priority Data
Feb. 10, 2025 (CN) 202510147583.9

(51) Int. Cl. H02P 27/08; H02P 29/024

(52) U.S. Cl. CPC H02P 27/08; H02P 29/0241; H02P 29/027

(57) ABSTRACT

A method for feedback control of a motor based on pulse width modulation, including: establishing, in a main control board of the motor, a first set of functional relationships between N different motor state signals and corresponding duty-cycles of a PWM signal; establishing a second set of functional relationships between A different motor state signals and corresponding frequencies of the PWM signal; receiving, by the main control board from the motor, the PWM signal including a duty-cycle component and a frequency component; and identifying, by the main control board, each motor state signal based on the duty-cycle range and the frequency range; calculating an actual value of the duty-cycle component and an actual value of the frequency component respectively based on the first and the second sets of functional relationships; and adjusting one or more target operating parameters of the motor according to the calculated actual values.

### CROSS-REFERENCE TO RELATED APPLICATIONS

Pursuant to 35 U.S.C.§ 119 and the Paris Convention Treaty, this application claims foreign priority to Chinese Patent Application No. 202510147583.9 filed Feb. 10, 2025, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of motor control technology, and more particularly, to a method and device for feedback control of a motor based on pulse width modulation (PWM).

In conventional motor control systems, PWM technology is widely used to regulate parameters such as motor speed, torque, and power output. PWM provides an efficient means of controlling power delivery by adjusting the duty cycle of a voltage signal applied to the motor, thereby varying the average voltage and improving control precision. However, existing PWM-based control systems often lack a robust feedback mechanism capable of maintaining optimal motor performance under varying load or environmental conditions.

In many HVAC applications, both permanent split capacitor (PSC) motors and PWM-controlled motors are typically operated under open-loop control or with limited feedback—usually a single signal representing motor speed. This minimal feedback makes it difficult for the main control board to accurately assess and adjust the motor’s operational state, often leading to performance instability, reduced efficiency, and delayed system response.

### SUMMARY

To solve the aforesaid problems, the first objective of the disclosure is to provide a method for feedback control of a motor based on pulse width modulation (PWM).

The motor comprises a signal feedback circuit or the signal feedback circuit is electrically connected to the motor to receive a feedback signal from the motor and output a control signal. The method comprises:

S1: establishing, in a main control board of the motor, a first set of functional relationships between N different motor state signals and corresponding duty cycles (d) of a PWM signal, defining a distinct and non-overlapping duty-cycle range for each of the first set of functional relationships; establishing, in the main control board, a second set of functional relationships between A different motor state signals and corresponding frequencies (f) of the PWM signal, and defining a distinct and non-overlapping frequency range for each of the second set of functional relationships;

S2: receiving, by the main control board from the motor, the PWM signal comprising a duty-cycle component and a frequency component, wherein the PWM signal integrates a plurality of motor state signals; and

S3: identifying, by the main control board, each motor state signal based on the duty-cycle range and the frequency range; calculating, by the main control board, an actual value of the duty-cycle component and an actual value of the frequency component respectively based on the first set of functional relationships and the second set of functional relationships; and adjusting, by the main control board, one or more target operating parameters of the motor according to the actual values.

In a class of this embodiment, the method further comprises:

S1: defining a transmission cycle for the motor and dividing the transmission cycle into M time slots, each time slot being assigned a duty-cycle component corresponding to a respective motor state signal, thereby enabling the motor to cyclically transmit the motor state signals in the transmission cycle.

In S1, N, A, and M are integers satisfying N > 1, A > 1, and M ≥ N.

In a class of this embodiment, the motor comprises a motor drive unit, a motor control unit, a plurality of duty cycle units, and a first timing counter. The motor drive unit is coupled to the motor control unit. The motor control unit is coupled to the plurality of duty cycle units and the first timing counter. The motor drive unit is configured to drive motor rotation. The motor control unit is configured to control motor operation, initialize motor-related variables, and extract operating parameters of the motor. Each of the plurality of duty cycle units is configured to convert a specific motor state signal into a value for the duty-cycle component. The first timing counter is configured to define and manage the transmission intervals of the motor state signals. The main control board comprises a first signal receiving unit, a plurality of duty-cycle decoding units, and a main control unit. The first signal receiving unit is coupled to the plurality of duty-cycle decoding units. The plurality of duty-cycle decoding units are coupled to the main control unit. The first signal receiving unit is configured to receive the duty-cycle components and identify each duty-cycle signal based on the assigned duty-cycle range. Each of the plurality of duty-cycle decoding units is configured to calculate the actual value of each duty-cycle component based on the first set of functional relationships. The main control unit is configured to adjust one or more target motor parameters based on the actual value of each duty-cycle component.

In a class of this embodiment, the motor further comprises a control signal parsing unit, a plurality of frequency units, and a second timing counter. The control signal parsing unit is coupled to the plurality of frequency units and the second timing counter. The control signal parsing unit is configured to parse a control signal. Each of the plurality of frequency units is configured to convert a specific motor state signal into a frequency component. The main control board further comprises a second signal receiving unit and a plurality of frequency decoding units. The second signal receiving unit is coupled to the plurality of frequency decoding units. The plurality of frequency decoding units are coupled to the main control unit. The second signal receiving unit is configured to receive the frequency components and identify each frequency component based on the assigned frequency range. Each of the plurality of frequency decoding units is configured to calculate the actual value of each frequency component based on the second set of functional relationships. The main control unit is configured to adjust one or more target motor parameters based on the actual value of each frequency component.

In a class of this embodiment, the motor further comprises a fault detection unit and a plurality of fault-state frequency units. The fault detection unit is coupled to the plurality of fault-state frequency units. The fault detection unit is configured to monitor and detect motor faults. Each of the plurality of fault-state frequency units is configured to convert a detected fault signal into a fault frequency component. The main control board further comprises a third signal receiving unit and a plurality of fault decoding units. The third signal receiving unit is coupled to the plurality of fault decoding units. The plurality of fault decoding units are coupled to the main control board. The third signal receiving unit is configured to receive and identify the fault frequency component. Each of the plurality of fault decoding units is configured to calculate an actual value of a corresponding fault frequency component based on the second set of functional relationships. The main control unit is configured to adjust one or more target motor parameters based on the actual value of each fault frequency component.

In a class of this embodiment, the one or more target motor parameters include, but are not limited to, rotational speed, torque, and airflow.

In a class of this embodiment, the motor state signals include, but are not limited to, a power signal, a speed signal, a state signal, a bus voltage signal, a current signal, a standby-state signal, and a torque signal.

In a class of this embodiment, the plurality of duty cycle units include, but are not limited to, a speed-based duty cycle unit, a power-based duty cycle unit, a state-based duty cycle unit, and a shutdown-state duty cycle unit.

In a class of this embodiment, the plurality of duty-cycle decoding units include, but are not limited to, a speed signal decoding unit, a power signal decoding unit, and a state signal decoding unit.

The signal feedback circuit is selected from a group consisting of an optocoupler feedback circuit, a transistor feedback circuit, or a combination thereof.

The second objective of the disclosure is to provide a device implementing the method.

The following advantages are associated with the disclosed method.

The disclosure provides a control arrangement in which the motor communicates with the main control board through the signal feedback circuit and software logic control. This arrangement enables real-time feedback of multiple motor operating states, allowing the main control board to accurately and dynamically adjust the target operating parameters of the motor based on the components received. Integrating the processing logic across both hardware and software levels simplifies the electrical connection between the main control board and the motor, thereby reducing component count and manufacturing cost. The components are interpreted through the predefined functional relationships within defined PWM parameter ranges, helping to maintain stable motor performance and reduce the occurrence of abnormal conditions. In addition, the use of structured PWM parameter settings and defined functional mapping allows faults to be quickly identified and isolated. Maintenance personnel can locate and correct issues efficiently, improving overall reliability and serviceability.

### BRIEF DESCRIPTION OF THE DRAWINGS

FIG. 1 is a schematic diagram of an optocoupler feedback circuit according to one example of the disclosure;

FIG. 2 is a schematic diagram of a transistor feedback circuit according to one example of the disclosure;

FIG. 3 is a diagram of a first example of a software logic control according to one example of the disclosure;

FIG. 4 is a diagram of a second example of a software logic control according to one example of the disclosure; and

FIG. 5 is a diagram of a third example of a software logic control according to one example of the disclosure.

### DETAILED DESCRIPTION

To further illustrate the disclosure, embodiments detailing a method for feedback control of a motor based on pulse width modulation are described below. It should be noted that the following embodiments are intended to describe and not to limit the disclosure.

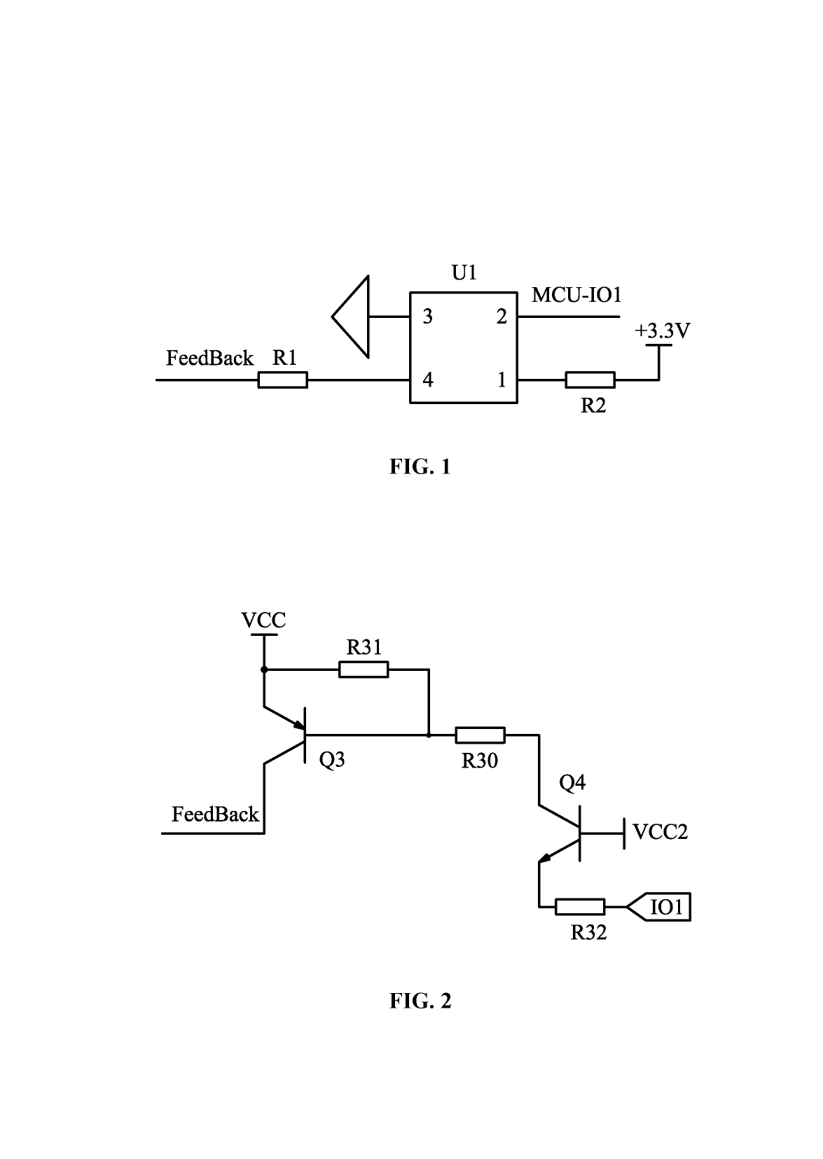

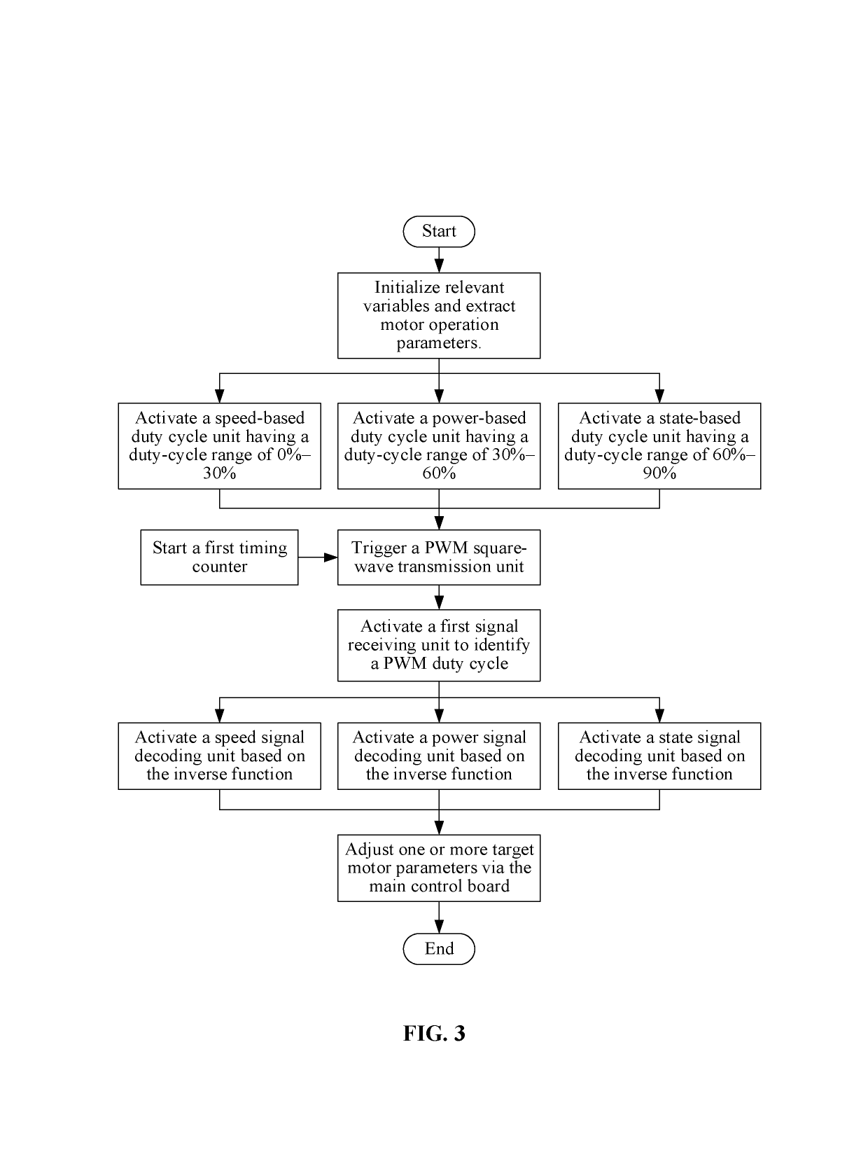

As illustrated in FIGS. 1–5, the disclosure provides a method for feedback control of a motor based on pulse width modulation (PWM). The motor comprises a signal feedback circuit or the signal feedback circuit is electrically connected to the motor to receive a feedback signal from the motor and output a control signal. The signal feedback circuit is an optocoupler feedback circuit, a transistor feedback circuit, or a combination thereof.

The method comprises:

S1. In a main control board, a plurality of functional relationships are established as follows: A first set of functional relationships is defined between N different motor state signals and corresponding duty cycles (d) of a PWM signal. A distinct and non-overlapping duty-cycle range is defined for each of the first set of functional relationships. A second set of functional relationships is defined between A different motor state signals and corresponding frequencies (f) of the PWM signal. A distinct and non-overlapping frequency range is defined for each of the second set of functional relationships. A transmission cycle for the motor is further defined and divided into M time slots. During each time slot, the motor transmits a duty-cycle component corresponding to a specific motor state signal. The motor cyclically outputs the duty-cycle components according to the defined transmission cycle. The integers N, A, and M satisfy N > 1, A > 1, and M ≥ N. The motor is a permanent split capacitor (PSC) motor or a PWM motor.

In a preferred embodiment, M = N, and each time slot within a transmission cycle has an equal duration. The motor state signals may include, for example, a power signal, a speed signal, a state signal, a bus voltage signal, a current signal, a standby-state signal, and a torque signal.

S2. The motor outputs the PWM signal comprising a duty-cycle component and a frequency component to the main control board. The PWM signal integrates a plurality of motor state signals.

S3. The main control board identifies each motor state signal based on the duty-cycle range and frequency range, and calculates an actual value of the duty-cycle component and an actual value of the frequency component respectively based on the first set of functional relationships and the second set of functional relationships. The main control board then adjusts the target operating parameters of the motor according to the actual values.

In one embodiment, the target operating parameters include, but are not limited to, rotational speed, torque, and airflow.

The signal feedback circuit and the main control board are integrated within the motor or mounted as part of an air-conditioning system or other control apparatus.

In one embodiment, the motor outputs a power signal, a speed signal, and a state signal to the main control board through the signal feedback circuit. The method operates as follows:

S10. The first set of functional relationships is defined between different motor state signals and corresponding duty cycles of the PWM signal, such that the duty cycle varies according to the magnitude of the corresponding operating parameters. Distinct duty-cycle ranges are assigned to the respective motor state signals.

For example, the first set of functional relationships is defined as follows:

Speed-based duty cycle: d₁ = d(RPM), with a range of 1%–30%;

Power-based duty cycle: d₂ = d(HP), with a range of 30%–60%; and

State-based duty cycle: d₃ = d(FO), with a range of 60%–90%.

S20. The motor cyclically transmits the duty-cycle components to the main control board according to a transmission cycle T.

In one embodiment, the transmission period T is set to 30 seconds and is divided into sequential time slots as follows: For example, when the power-based duty cycle , the speed-based duty cycle, and the state-based duty cycle are transmitted, the transmission period T may be defined as 30 seconds, divided into sequential time slots as follows: From 0 to 10 seconds, the power duty cycle is transmitted; from 11 to 20 seconds, the speed duty cycle is transmitted; and from 21 to 30 seconds, the state-based duty cycle is transmitted.

S30. The main control board receives the three duty cycles, identifies each duty cycle based on the corresponding duty-cycle range, and calculates the actual value of each duty cycle using the first set of functional relationships. The main control board then adjusts the target operating parameters of the motor based on the actual value of each duty cycle.

S100. The second set of functional relationships is further established between different motor state signals and corresponding frequencies, such that the value of each frequency varies according to the magnitude of the corresponding operating parameter of the motor. For example:

Speed-based frequency: f₁ = f(RPM), defined as f₁ = speed / 10, with a frequency range of 60–200 Hz;

Power-based frequency: f₂ = f(HP), where 1/3 HP = 275 Hz, 1/2 HP = 300 Hz, 3/4 HP = 325 Hz, and 1 HP = 350 Hz;

Fault-state frequency: f₃ = f(FO), defined as 400 Hz for overvoltage, 425 Hz for undervoltage, and 450 Hz for overcurrent; and

Standby-state frequency: f₄ = f(STOP), defined as f₄ = 30 Hz.

S200. The frequencies, as attributes of the PWM signal, are transmitted to the main control board in accordance with the predefined logic sequence. The transmissions may be combined with gear position signals and other operating parameters of the motor to ensure accurate state reporting.

S300. When a fault condition is detected within the motor, the motor immediately outputs the fault frequency component f₃ to the main control board for prompt fault identification.

S400. Upon receiving the frequencies, the main control board identifies each frequency based on the assigned frequency ranges, computes the actual value of each frequency using the second set of functional relationships. The main control board then adjusts the target operating parameters of the motor based on the actual values.

In S10 and S100, additional duty-cycle ranges, frequency ranges, and corresponding functional relationships may be defined based on specific requirements or the number of motor state signals to be monitored. Correspondingly, in S20, the number and duration of time slots within each transmission cycle may be adjusted to accommodate the expanded set of motor state signals.

In one embodiment, the motor comprises a motor drive unit, a motor control unit, a plurality of duty cycle units, and a first timing counter. The motor drive unit is coupled to the motor control unit. The motor control unit is coupled to the plurality of duty cycle units and the first timing counter. The motor drive unit is configured to drive motor rotation. The motor control unit is configured to control motor operation, initialize motor-related variables, and extract operating parameters of the motor. Each of the plurality of duty cycle units is configured to convert a specific motor state signal into a value of a duty-cycle component. The first timing counter is configured to define and manage the transmission intervals of the motor state signals.

The main control board comprises a first signal receiving unit, a plurality of duty-cycle decoding units, and a main control unit. The first signal receiving unit is coupled to the plurality of duty-cycle decoding units. The plurality of duty-cycle decoding units are coupled to the main control unit. The first signal receiving unit is configured to receive the duty-cycle components and identify each duty-cycle component based on the assigned duty-cycle range. Each of the plurality of duty-cycle decoding units is configured to calculate the actual value of a corresponding duty-cycle component based on the first set of functional relationships. The main control unit is configured to adjust one or more target motor parameters based on the actual value of each duty-cycle component.

The motor further comprises a control signal parsing unit, a plurality of frequency units, and a second timing counter. The control signal parsing unit is coupled to the plurality of frequency units and the second timing counter. Each of the plurality of frequency units is configured to convert a motor control signal into a value of a frequency component. The main control board further comprises a second signal receiving unit and a plurality of frequency decoding units. The second signal receiving unit is coupled to the plurality of frequency decoding units. The plurality of frequency decoding units is coupled to the main control unit. The second signal receiving unit is configured to receive the frequency and identify each frequency signal based on the assigned frequency range. Each of the plurality of frequency decoding units is configured to calculate the actual value of a corresponding frequency based on the second set of functional relationships. The main control unit is configured to adjust one or more target motor parameters based on the actual value of each frequency component.

The motor further comprises a fault detection unit and a plurality of fault-based frequency units. The fault detection unit is coupled to the plurality of fault-based frequency units. The fault detection unit is configured to monitor and detect motor faults. Each of the plurality of fault-state frequency units is configured to convert a detected fault signal into a fault-state frequency. The main control board further comprises a third signal receiving unit and a plurality of fault decoding units. The third signal receiving unit is coupled to the plurality of fault decoding units. The plurality of fault decoding units are coupled to the main control board. The third signal receiving unit is configured to receive and identify the fault-state frequency. Each of the plurality of fault decoding units is configured to calculate the actual value of a corresponding fault-state frequency based on the second set of functional relationships. The main control unit is configured to adjust one or more target motor parameters based on the actual values of each fault-state frequency.

In certain embodiment, the plurality of duty cycle units include a speed-based duty cycle unit, a power-based duty cycle unit, a state-based duty cycle unit, and a shutdown-state duty cycle unit. The plurality of duty-cycle decoding units include a speed signal decoding unit, a power signal decoding unit, and a state signal decoding unit. The PWM signal is a square wave characterized by the duty-cycle component and the frequency component.

Referring to FIG. 3, in one embodiment, when the motor enters a startup state, the motor control unit initializes motor-related variables and extracts operating parameters. The operating parameters are transmitted respectively to the speed-based duty cycle unit, the power-based duty cycle unit, and the state-based duty cycle unit. During a transmission cycle, the speed-based duty cycle unit, the power-based duty cycle unit, and the state-based duty cycle unit sequentially transmit corresponding duty cycles to the signal feedback circuit. In one embodiment, the speed-based duty cycle unit generates a speed-based duty cycle with a frequency range of 1% to 30%. The power-based duty cycle unit generates a power-based duty cycle with a range of 30% to 60%, and the state-based duty cycle unit generates a state-based duty cycle with a range of 60% to 90%. The signal feedback circuit receives the three duty cycles and converts each duty cycle into a corresponding PWM square-wave signal. The PWM square-wave signals are then transmitted to the main control board. The first signal receiving unit identifies the PWM square-wave signals according to the assigned duty-cycle range. The signal receiving unit then transmits the PWM square-wave signal to a speed signal decoding unit, a power signal decoding unit, or a state signal decoding unit. The speed signal decoding unit, the power signal decoding unit, or the state signal decoding unit perform an inverse function computation based on the first set of functional relationships so as to calculate the actual value of each PWM square-wave signal. The main control unit then adjusts one or more target motor parameters based on the actual value of each PWM square-wave signal.

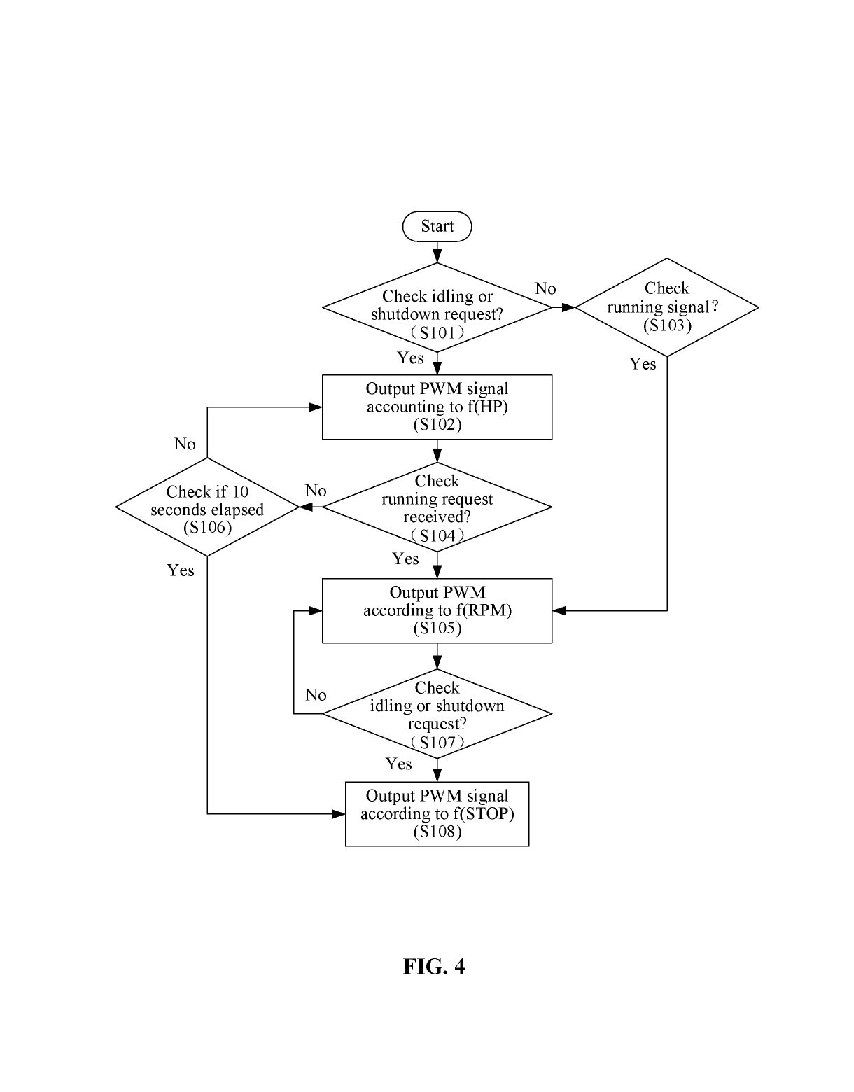

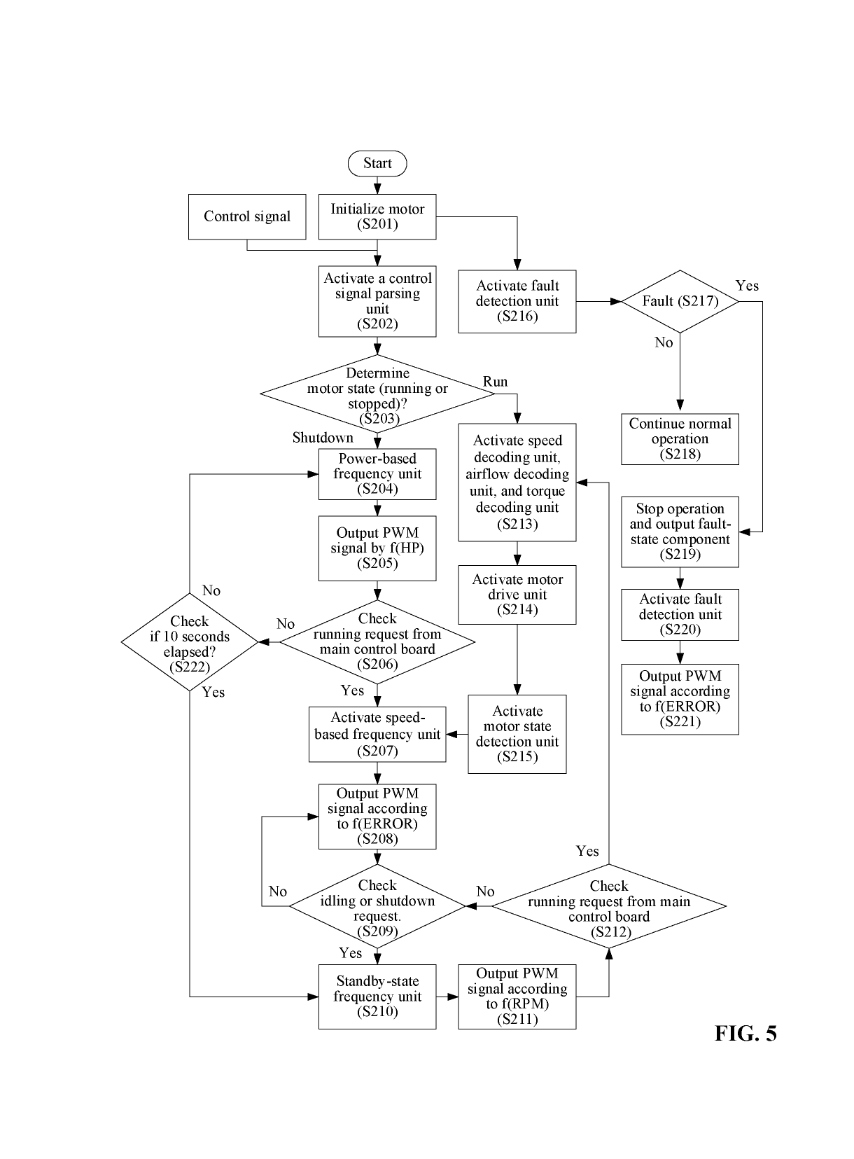

Referring to FIG. 4, in one embodiment, when the motor enters a startup state, the process enters step S101. At step S101, the control signal parsing unit determines whether an idle or shutdown request is present. When an idle or shutdown request is detected, the process proceeds to step S102. At step S102, the control signal parsing unit outputs a PWM signal according to the function f(HP). When no idle or shutdown request is detected at step S102, the process advances to step S103. At step S103, the control signal parsing unit checks whether a run command signal is received. When a run command is detected, the process moves to step S105, and a PWM signal corresponding to the speed frequency is output. After completion of step S102, the process continues to step S104. At step S104, the control signal parsing unit checks whether a run command is received. When a run command is present, the process advances to step S105, and a PWM signal is output according to the function f(RPM). When no run command is received at step S104, the process advances to step S106. At step S106, a timer determines whether a duration of 10 seconds has elapsed. When the duration exceeds 10 seconds, the process proceeds to step S108, and a PWM signal is output according to the function f(STOP). When the duration does not exceed 10 seconds, the process returns to step S102 for re-evaluation. After completion of step S105, the process advances to step S107. At step S107, the control signal parsing unit again determines whether an idle or shutdown request is present. When such a request is detected, the process transitions to step S108, where a PWM signal is output according to the function f(STOP). When no idle or shutdown request is detected, the process returns to step S105 to continue outputting the speed PWM signal.

Referring to FIG. 5, in one embodiment, when the motor enters a startup state, the process proceeds to step S201. At step S201, the motor control unit initializes variables associated with motor operation. At step S202, the motor control unit sends a control signal to the control signal parsing unit. At step S203, the control signal parsing unit determines whether the motor is in a running state or a stopped state. When the motor is identified as being in the stopped state at step S203, the process continues to step S204. At step S204, the power-based frequency unit receives the control signal and performs processing. At step S205, the power-based frequency unit outputs a PWM signal according to the function f(HP). At step S206, the control signal parsing unit checks whether a run request from the main control board is received. When a run request is detected, the process advances to step S207, where a speed-based frequency unit receives the control signal and performs processing. At step S208, the speed-based frequency unit outputs a speed PWM signal according to the function f(RPM). After step S208, the process proceeds to step S209. At step S209, the control signal parsing unit determines whether an idle or shutdown request is present. When an idle or shutdown request is detected, the process advances to step S210. At step S210, the standby-state frequency unit receives the idle or shutdown request and performs processing. At step S211, the standby-state frequency unit outputs a standby-state frequency according to the function f(STOP). After completion of step S211, the process continues to step S212. At step S212, the control signal parsing unit checks whether a new run request from the main control board is received. When the new run request is detected, the process proceeds to step S213. When no new run request is received, the process returns to step S209 for re-evaluation. When no run request is detected at step S206, the process advances to step S222. At step S222, a timer determines whether a duration of 10 seconds has elapsed. When the duration exceeds 10 seconds, the process transitions to step S210. When the duration does not exceed 10 seconds, the process returns to step S204 for further processing. When the motor is identified as being in the running state at step S203, the process advances to step S213. At step S213, the speed decoding unit, the airflow decoding unit, and the torque decoding unit respectively calculate the actual values of target speed, airflow, and torque. At step S214, the motor drive unit adjusts the target operating parameters of the motor based on the actual values. At step S215, a motor state detection unit monitors the adjusted parameters and then directs the process to return to step S207 for continued operation. After step S201, the fault detection unit performs diagnostic monitoring at step S216. At step S217, the fault detection unit determines whether a fault condition is present. When no fault is detected, the process advances to step S218, allowing the motor to continue normal operation. When a fault condition is detected at step S217, the process advances to step S219, where the motor stops operation and output a fault state component. At step S220, each fault-state frequency unit receives a corresponding fault-state component and performs processing. At step S221, the fault-state frequency unit outputs a PWM signal according to the function f(ERROR).

In one embodiment, a device implementing the above method is also disclosed. The device is an electric motor, an air conditioner, or another type of electronic product or equipment.

It will be obvious to those skilled in the art that changes and modifications may be made, and therefore, the aim in the appended claims is to cover all such changes and modifications.

What is claimed is:

1. A method for feedback control of a motor based on pulse width modulation, the motor comprising a signal feedback circuit or the signal feedback circuit being electrically connected to the motor to receive a feedback signal from the motor and output a control signal, and the method comprising:
S1: establishing, in a main control board of the motor, a first set of functional relationships between N different motor state signals and corresponding duty-cycles of a PWM signal, defining a distinct and non-overlapping duty-cycle range for each of the first set of functional relationships; establishing, in the main control board, a second set of functional relationships between A different motor state signals and corresponding frequencies of the PWM signal, and defining a distinct and non-overlapping frequency range for each of the second set of functional relationships;
S2: receiving, by the main control board from the motor, the PWM signal comprising a duty-cycle component and a frequency component, wherein the PWM signal integrates a plurality of motor state signals; and
S3: identifying, by the main control board, each motor state signal based on the duty-cycle range and the frequency range; calculating, by the main control board, an actual value of the duty-cycle component and an actual value of the frequency component respectively based on the first set of functional relationships and the second set of functional relationships; and adjusting, by the main control board, one or more target operating parameters of the motor according to the calculated actual values.

2. The method of claim 1, further comprising defining a transmission cycle for the motor and dividing the transmission cycle into M time slots, each time slot being assigned a duty-cycle component corresponding to a respective motor state signal, thereby enabling the motor to cyclically transmit the motor state signals in the transmission cycle.

3. The method of claim 2, wherein N A and M are integers satisfying N > 1, A > 1, and M ≥ N.

4. The method of claim 1, wherein the motor comprises a motor drive unit, a motor control unit, a plurality of duty-cycle units, and a first timing counter; the motor drive unit is coupled to the motor control unit; the motor control unit is coupled to the plurality of duty-cycle units and the first timing counter; the motor drive unit is configured to drive motor rotation; the motor control unit is configured to control motor operation, initialize motor-related variables, and extract operating parameters of the motor; each of the plurality of duty-cycle units is configured to convert a specific motor operation parameter into a duty-cycle component; the first timing counter is configured to define and manage transmission intervals of the motor state signals; the main control board comprises a first signal receiving unit, a plurality of duty-cycle decoding units, and a main control unit; the first signal receiving unit is coupled to the plurality of duty-cycle decoding units; the plurality of duty-cycle decoding units are coupled to the main control unit; the first signal receiving unit is configured to receive the duty-cycle components and identify each duty-cycle component based on the assigned duty-cycle range; each of the plurality of duty-cycle decoding units is configured to calculate an actual value of a corresponding duty-cycle component based on the first set of functional relationships; and the main control unit is configured to adjust one or more target motor parameters based on the actual value of each duty-cycle component.

5. The method of claim 1, wherein the motor further comprises a control signal parsing unit, a plurality of frequency units, and a second timing counter; the control signal parsing unit is coupled to the plurality of frequency units and the second timing counter; the control signal parsing unit is configured to parse a control signal; each of the plurality of frequency units is configured to convert a corresponding motor state signal into a frequency component; the main control board further comprises a second signal receiving unit and a plurality of frequency decoding units; the second signal receiving unit is coupled to the plurality of frequency decoding units; the plurality of frequency decoding units are coupled to the main control unit; the second signal receiving unit is configured to receive the frequency components and identify each frequency component based on the assigned frequency range; each of the plurality of frequency decoding units is configured to calculate an actual value of a corresponding frequency component based on the second set of functional relationships; and the main control unit is configured to adjust one or more target motor parameters based on the actual value of each frequency component.

6. The method of claim 4, wherein the motor further comprises a control signal parsing unit, a plurality of frequency units, and a second timing counter; the control signal parsing unit is coupled to the plurality of frequency units and the second timing counter; the control signal parsing unit is configured to parse a control signal; each of the plurality of frequency units is configured to convert a corresponding motor state signal into a frequency component; the main control board further comprises a second signal receiving unit and a plurality of frequency decoding units; the second signal receiving unit is coupled to the plurality of frequency decoding units; the plurality of frequency decoding units are coupled to the main control unit; the second signal receiving unit is configured to receive the frequency components and identify each frequency component based on the assigned frequency range; each of the plurality of frequency decoding units is configured to calculate an actual value of a corresponding frequency component based on the second set of functional relationships; and the main control unit is configured to adjust one or more target motor parameters based on the actual value of each frequency component.

7. The method of claim 5, wherein the motor further comprises a fault detection unit and a plurality of fault-state frequency units; the fault detection unit is coupled to the plurality of fault-state frequency units; the fault detection unit is configured to monitor and detect motor faults; each of the plurality of fault-state frequency units is configured to convert a detected fault signal into a fault frequency component; the main control board further comprises a third signal receiving unit and a plurality of fault decoding units; the third signal receiving unit is coupled to the plurality of fault decoding units; the plurality of fault decoding units are coupled to the main control board; the third signal receiving unit is configured to receive and identify the fault frequency components; each of the plurality of fault decoding units is configured to calculate an actual value of each fault frequency component based on the second set of functional relationships; and the main control unit is configured to adjust one or more target motor parameters based on the actual value of each fault frequency component.

8. The method of claim 6, wherein the motor further comprises a fault detection unit and a plurality of fault-state frequency units; the fault detection unit is coupled to the plurality of fault-state frequency units; the fault detection unit is configured to monitor and detect motor faults; each of the plurality of fault-state frequency units is configured to convert a detected fault signal into a fault frequency component; the main control board further comprises a third signal receiving unit and a plurality of fault decoding units; the third signal receiving unit is coupled to the plurality of fault decoding units; the plurality of fault decoding units are coupled to the main control board; the third signal receiving unit is configured to receive and identify the fault frequency components; each of the plurality of fault decoding units is configured to calculate an actual value of each fault frequency component based on the second set of functional relationships; and the main control unit is configured to adjust one or more target motor parameters based on the actual value of each fault frequency component.

9. The method of claim 7, wherein the one or more target motor parameters are rotational speed, torque, or airflow.

10. The method of claim 8, wherein the one or more target motor parameters are rotational speed, torque, or airflow.

11. The method of claim 7, wherein the motor state signals comprise a power signal, a speed signal, a state signal, a bus voltage signal, a current signal, a standby-state signal, and a torque signal; the plurality of duty-cycle units comprise a speed-based duty cycle unit, a power-based duty cycle unit, a state-based duty cycle unit, and a shutdown-state duty cycle unit; and the plurality of duty-cycle decoding units comprise a speed signal decoding unit, a power signal decoding unit, or a state signal decoding unit.

12. The method of claim 8, wherein the motor state signals comprise a power signal, a speed signal, a state signal, a bus voltage signal, a current signal, a standby-state signal, and a torque signal; the plurality of duty-cycle units comprise a speed-based duty cycle unit, a power-based duty cycle unit, a state-based duty cycle unit, and a shutdown-state duty cycle unit; and the plurality of duty-cycle decoding units comprise a speed signal decoding unit, a power signal decoding unit, or a state signal decoding unit.

13. The method of claim 1, wherein the signal feedback circuit is selected from a group consisting of an optocoupler feedback circuit, a transistor feedback circuit, and a combination thereof.

14. A motor control device configured to perform the method of claim 1.

15. The motor control device of claim 14, wherein the method further comprises defining a transmission cycle for the motor and dividing the transmission cycle into M time slots, each time slot being assigned a duty-cycle component corresponding to a respective motor state signal, thereby enabling the motor to cyclically transmit the motor state signals in the transmission cycle.
